(19) United States
(12) Patent Application Publication
(10) Pub. No.: US 2017/0103831 A1
(43) Pub. Date: Apr. 13, 2017

(54) Methods for Manufacturing an Insulated Busbar

(71) Applicant: LITTELFUSE, INC., Chicago, IL (US)

(72) Inventors: Weiqing Guo, Palo Alto, CA (US); Jianhua Chen, Sunnyvale, CA (US)

(73) Assignee: LITTELFUSE, INC., Chicago, IL (US)

(21) Appl. No.: 14/882,396

(22) Filed: Oct. 13, 2015

(51) Int. Cl. H01B 13/00; H01B 13/34; H01B 3/40; H01B 3/44; H01B 3/30; H01B 13/06; H01B 3/42

(52) U.S. Cl. CPC H01B 13/0003; H01B 13/065; H01B 13/345; H01B 3/421; H01B 3/447; H01B 3/307; H01B 3/40; H01B 3/443; H01B 3/302; H01B 3/305; H01B 3/303

(57) ABSTRACT

A method for manufacturing an insulated conductive material includes providing a continuous feed of a conductive material, a first continuous feed of insulating material above a top surface of the conductive strip, and a second continuous feed of insulating material below a bottom surface of the conductive strip. Portions of the first and second continuous feeds of insulating material are compressed against a portion of the conductive material. The portions of the first and second insulating material are cured to thereby provide a continuous feed of insulated conductive material.

### BACKGROUND

Field of the Invention

The present invention relates generally to insulated conductors. More specifically, the present invention relates methods for manufacturing insulating busbars.

Description of Related Art

A typical mobile device may utilize two or more battery cells to provide power to the mobile device. The batteries may be connected in series or parallel configurations via so-called busbars, which typically correspond to one or more strips of conductive material suitably sized to handle the required amount of current.

Insulation of the busbar is usually required to prevent a short circuit condition between the busbar and other electrical components of the mobile device. One method for manufacturing and insulated busbar includes cutting a length of a conductive material to a desired length and cutting two portions of an insulating material to the same length. For example, the respective components may be cut to a length of 20 cm. The respective portions of insulating material are placed on the top and bottom surface of the conductive material, respectively, to insulate the conductive material, and thereby provide an insulated busbar.

However, the operations described above are time consuming and do not lend themselves well to mass production. For example, there may be numerous sections of insulated busbar required in a given assembly. Each insulated busbar may have a different length. As noted above, three cutting steps may be required to manufacture a single busbar. Thus, the number cutting operations involved in manufacturing the assembly of busbars may be three times the number of busbar sections.

Other problems with existing methods for manufacturing insulated busbars will become apparent in view of the disclosure below.

### SUMMARY

In one aspect, a method for manufacturing an insulated conductive material is provided. The method includes providing a continuous feed of a conductive material, a first continuous feed of insulating material above a top surface of the conductive strip, and a second continuous feed of insulating material below a bottom surface of the conductive strip. Portions of the first and second continuous feeds of insulating material are compressed against a portion of the conductive material. The portions of the first and second insulating material are cured to thereby provide a continuous feed of insulated conductive material.

In a second aspect, a method for manufacturing an insulated conductive material is provided. The method includes providing a continuous feed of a conductive material, and an extrusion mold that defines an extrusion opening sized larger than a cross-section of the conductive material. An insulating material is inserted into the extrusion mold. The continuous feed of the conductive material is run through the extrusion mold and out the extrusion opening. The extrusion mold is configured such that an entire outside surface of the conductive material is covered with the insulating material when the conductive material exits the extrusion mold. The insulated conductive material is cured as it exits the extrusion mold to thereby provide a continuous feed of insulated conductive material.

In a third aspect, a method for manufacturing an insulated conductive material is provided. The method includes providing a continuous feed of a conductive material and electrically charging the conductive material with a first charge polarity. The method further includes providing a medium of electrically charged insulating material particles that are charged with an opposite polarity. The charged conductive material is passed through the medium, where the insulating material particles bind to the conductive material and cover an entire outside surface of the conductive material. The insulating material particles are cured to thereby provide a continuous feed of insulated conductive material.

In a fourth aspect, a method for manufacturing an insulated conductive material is provided. The method includes providing a continuous feed of a conductive material and spraying an insulating material over the exterior surface of the conductive material. The insulating material particles are then cured to thereby provide a continuous feed of insulated conductive material.

### BRIEF DESCRIPTION OF THE DRAWINGS

FIG. 1A illustrates a first exemplary embodiment 100 of a system for manufacturing an arbitrarily long insulated busbar in which insulated material is laminated onto a conductive material;

FIG. 1B illustrates an insulated busbar with exposed sections of conductive material;

FIG. 2 illustrates a second exemplary embodiment of a system for manufacturing an arbitrarily long insulated busbar in which insulated material is extruded over a conductive material;

FIGS. 3 and 4 illustrate third and fourth exemplary embodiments of a system for manufacturing an arbitrarily long insulated busbar in which insulated material is electrically deposited onto a conductive material;

FIG. 5 illustrates a fifth exemplary embodiment of a system for manufacturing an arbitrarily long insulated busbar in which insulating material is sprayed onto a conductive material; and

FIG. 6 illustrates a sixth exemplary embodiment of a system for manufacturing an arbitrarily long insulated busbar in which a conductive material is inserted into tubing formed from a heat shrink tubing material.

### DETAILED DESCRIPTION

Methods and systems for manufacturing insulated busbars are described below. In general, the methods and systems facilitate manufacturing an arbitrarily long insulated busbar that can be cut to any desired length. The methods and systems reduce the number of cutting operations necessary to manufacture an assembly of busbars.

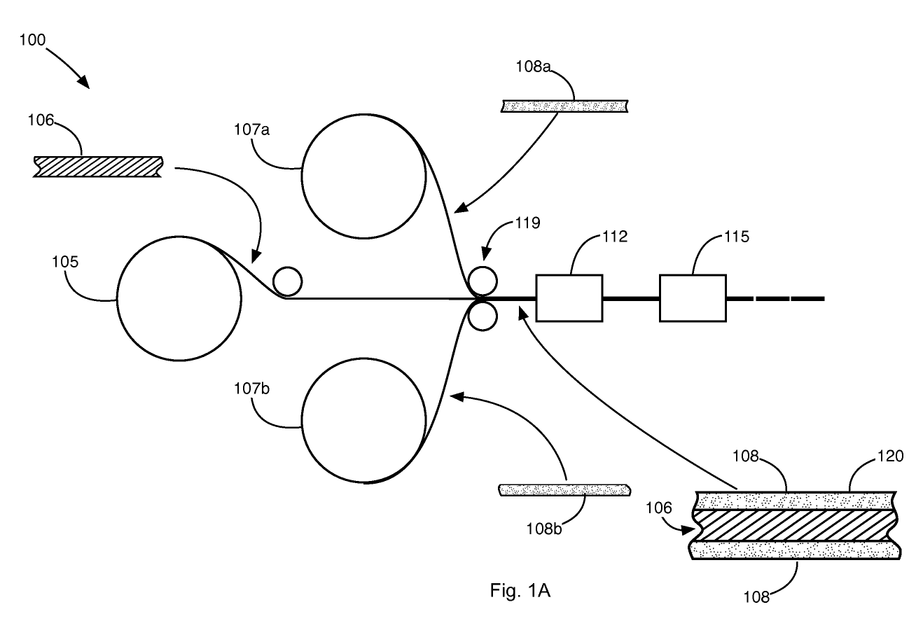

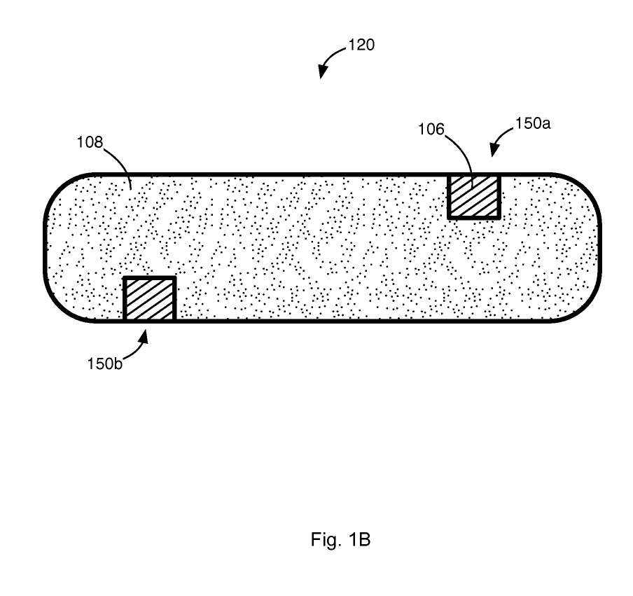

FIG. 1A illustrates a first exemplary embodiment 100 of a system for manufacturing an arbitrarily long insulated busbar. Shown is a reel of conductive material 105, first and second reels of insulation material 107ab, a compression section 119, a curing station 112, and a cutting station 115.

The conductive material 106 on the reel of conductive material 105 may be copper or a different conductive material or composition of conductive materials. The conductive material 105 may have a thickness of about 0.1-2 mm, and a width about 2-12 mm. Other dimensions are possible.

The insulation material 108ab on the reels of insulation material 107ab may correspond to a thermoplastic film such as polyolefin, polyvinyl chloride, nylon, polyester, fluoride polymer, and PEI, or a different material with similar insulating properties. The insulation material 108ab may have a thickness of about 15-100 μm and a width of about 2-12 mm. Other dimensions are possible and may be selected to complement the dimensions of the conductive material 106. For example, the width of the insulation material 108ab may be slightly larger than the width of the conductive material 106 to facilitate covering the side surfaces of the conductive material 106 along with the top and bottom surfaces of the conductive material 106.

In some implementations, the insulation material 108a on the first reel 107a may be different from the insulation material 108b on the second reel 107b. For example, one the insulation materials 108b may have adhesive properties to facilitate adhering the final busbar product to a surface.

The compression section 119 may correspond to a pair of rollers arranged above and below the conductive material 106 configured to apply pressure to the insulation material 108ab to thereby press the insulation material 108ab against the top and bottom surfaces of the conductive material 106. For example, the rollers may be configured to apply a pressure of about 150 PSI to the insulation material 108ab. Other methods for compressing the insulation material 108ab against the conductive material 106 may be utilized. An arbitrarily long insulated busbar 120, that is insulated on all sides, may exit the compression section 119.

In some implementations, a curing section 112 may be provided to cure the insulation material 108ab of the insulated busbar 120 after it has been applied to the conductive material 106. For example, the curing section 112 may be configured to heat to the insulated busbar 120 to a temperature of about 60-100 degrees. In other implementations, the curing section 112 may correspond to a cooling station configured to cool previously heated insulation material 108ab of the insulated busbar 120.

In some implementations, a cutting station 115 may be provided to cut the insulated busbar 120 into arbitrary or fixed length sections. For example, a cutting knife may cut the insulated busbar 120. Other cutting methods may be employed to cut the insulated busbar 120.

In yet other implementations, an etching station (not shown) may be provided to etch portions 150ab of the insulation material 108ab from the insulated busbar 120 to expose the conductive material 106, as illustrated in FIG. 1A. For example, a laser may be utilized to selectively remove portions of the insulation material 108ab. Other methods may be used to selectively remove the portions 150ab of insulation material. The exposed sections of conductive material 106 may be joined to expose sections of other insulated busbars, battery terminals, circuit boards, etc., via soldering, welding, and the like.

Additionally, or alternatively, one or more openings (not shown) may be pre-cut into the insulation material 108ab such that areas of the conductive material 106 below the openings are exposed prior to curing.

In operation, the respective materials may roll off their respective reels towards the compression section 119. In some implementations, the insulation material 108ab may be pre-heated so that the insulation material 108ab conforms to the conductive material 106 and any irregularities that may be present on the conductive material 106 during compression. The pressure applied by the compression section 119 maybe about 150 PSI. The feed rate at which the conductive material 106 and insulation material 108 roll off the respective reels may be about 3-10 feet per minute. The feed rate may be adjusted in conjunction with the temperature of the insulation material 108ab and/or the compressive force applied by the compression section 119 to control the thickness of the insulation material 108ab.

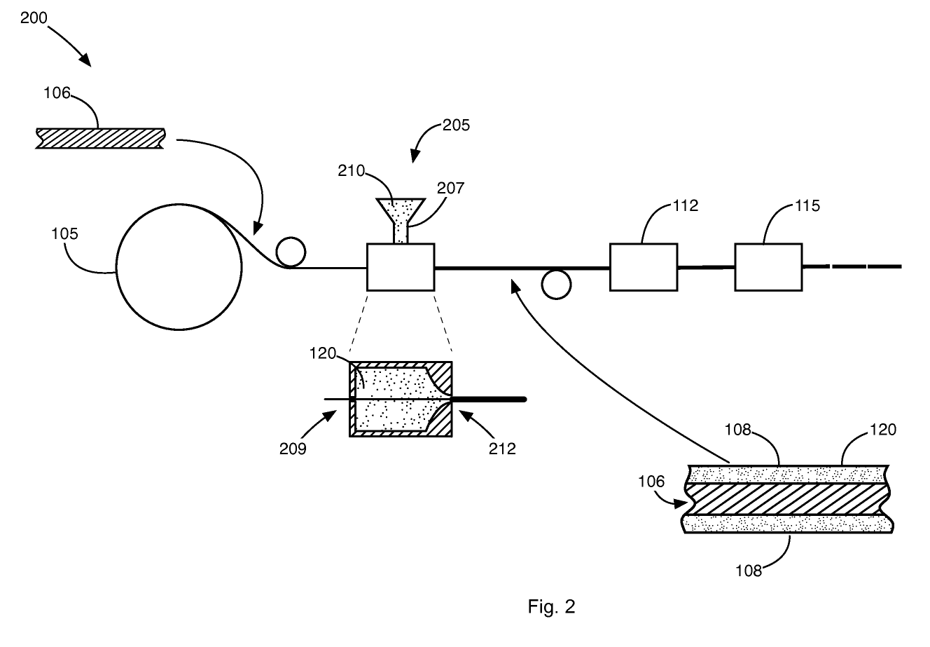

FIG. 2 illustrates a second exemplary embodiment 200 of a system for manufacturing an arbitrarily long insulated busbar. Shown is a reel of conductive material 105, an extrusion mold 205, a curing station 112, and a cutting station 115.

In the second exemplary embodiment, an extrusion mold 205 is utilized to apply a pelletized version of insulation material 210 to the conductive material 105. In this regard, the pelletized insulation material 210 may correspond to a thermoplastic such as polyolefin, polyvinyl chloride, nylon, polyester, and fluoride polymer, or a different material with similar insulating properties. The pelletized insulation material 210 may be loaded into a hopper 207 of the extrusion mold 205.

The extrusion mold 205 may have an input 209 through which the conductive material 106 enters and an outlet side 212 through which the insulated busbar exits. In this regard, the opening of the input 209 may be sized to be slightly larger than a cross section of the conductive material 106. For example, the dimensions of the opening of the input 209 may be about 0.5 by 6mm for a conductive material 106 having 1%-3% shrinkage from the opening dimensions.

The opening of the output 212 may be sized to control the final cross-section of the insulated busbar 120. The extrusion mold 205 may be configured so that the conductive material 106 is substantially centered within the opening of the output 212 as it exits so that the conductive material 106 is uniformly covered with melted insulation material 108 on all sides.

A curing section 112, such as the curing section described above, may be provided in some embodiments to cure the insulated busbar 120 as it exits the extrusion mold 205. In other embodiments, the insulated busbar 120 begins to cure upon exiting the extrusion mold 205.

A cutting station 115, such as the cutting station described above, may be provided to cut the insulated busbar 120 into arbitrary of fixed length sections. An etching station (not shown) may be provided to etch portions of the insulation material 108 from the insulated busbar 120 to expose the conductive material 106.

In operation, the conductive material 106 may roll off the reel of conductive material 105 and into the extrusion mold 205. The pelletized insulation material 210 may be heated within the extrusion mold 205 to a temperature of about 200C to melt the pelletized insulation material 210. A pressure of about 300 PSI may be applied to the melted insulation material 108 to cause the insulation material 108 to exit the output 212 of the extrusion mold 205 along with the conductive material 106. The feed rate at which the conductive material 106 and insulation material 108 exit the extrusion mold 205 may be about 2-5 feet per minute.

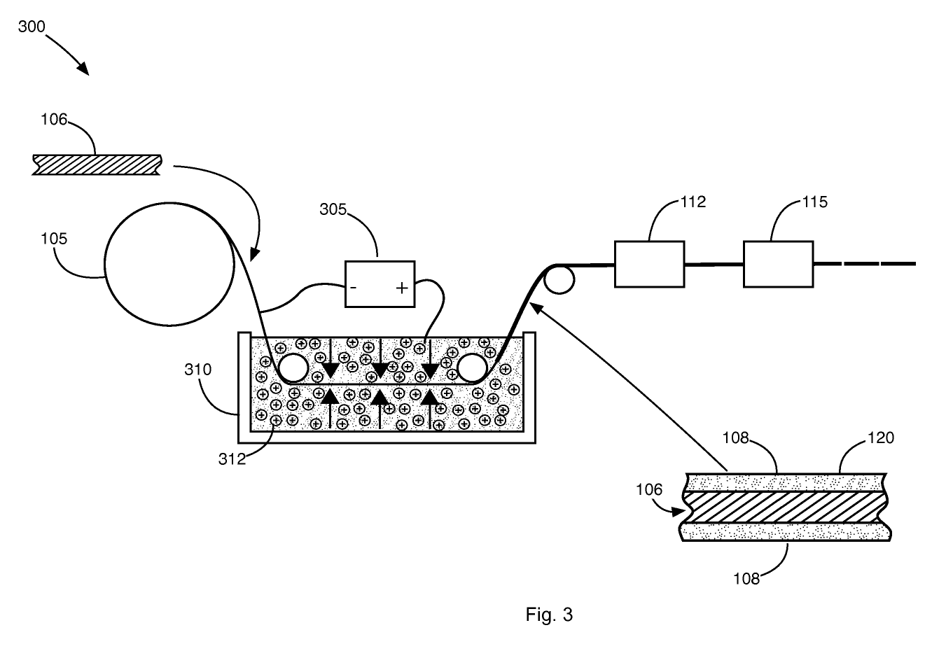

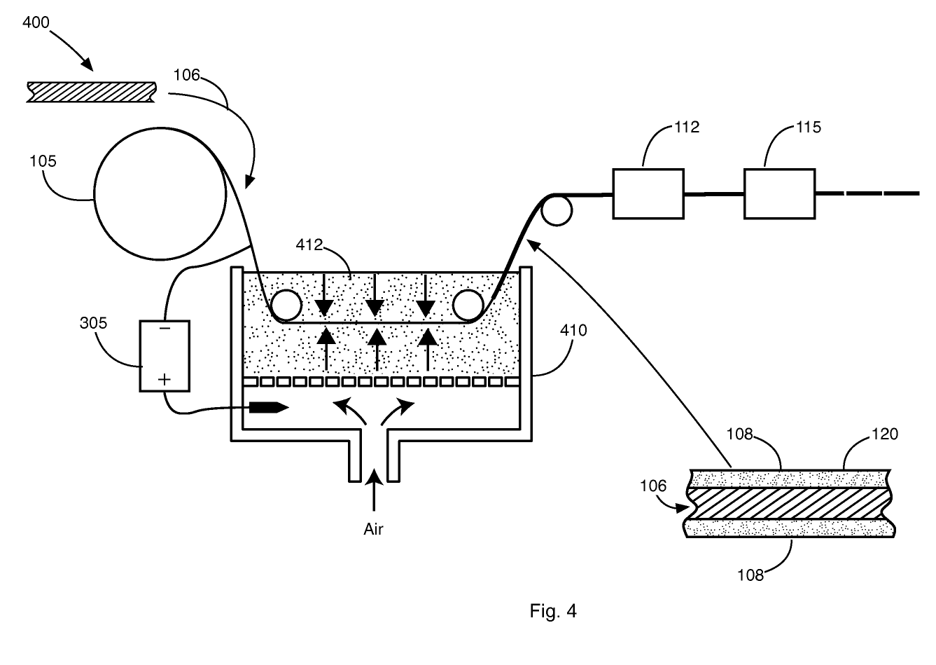

FIGS. 3 and 4 illustrate third and fourth exemplary embodiments (300, 400) of a system for manufacturing an arbitrarily long insulated busbar. Shown is a reel of conductive material 105, an insulation deposition chamber (310, 410), a curing station 112, and a cutting station 115.

In the third exemplary embodiment 300, the insulation deposition chamber 310 utilizes and cathodic electrodeposition method in which colloidal insulation material particles 312 are suspended in a liquid medium, such as acrylic base resins. The medium is coupled to a first polarity of a DC power source 305. The opposite polarity of the DC power source 305 is electrically coupled to the conductive material 106. The DC power source 305 may generate a voltage of about 20-80 Vdc. The insulation material particles 312 in the medium migrate under the influence of the electric field generated by the DC power source 305 to the outside surface of the conductive material 106 to thereby cover the entire outside surface of the conductive material 106 with the colloidal insulation material particles 312.

The insulation material particles 312 may correspond to any colloidal particles capable of forming a stable suspension, which can carry a charge. For example, the insulation material particles 312 may correspond to various polymers, pigments, dyes, and ceramics. Different materials with similar properties may be utilized.

The third exemplary embodiment is capable of producing an insulated busbar 120 having an insulation layer with a thickness of least 0.014 mm, a leakage current of less than 10 mA, and an insulation resistance of at least 100 MΩ when measured with 500V DC applied across the insulated busbar 120. In addition, the insulation 108 of the insulated busbar 120 maintains an ISO grade 0 cross-hatch adhesion rating to the conductive material 106 after the insulated busbar 120 is exposed to an environment of 60° C. having a relative humidity of 95% for 500 hours, and after cycling the temperature of the insulated busbar 120 one hundred times between −40° C. and 90° C.

In the fourth exemplary embodiment 400, the insulation deposition chamber 410 utilizes an electrostatic powder coating method in which ionized air charged with a first polarity of a DC power source 305 flows through insulation material particles 412 to thereby charge the insulation material particles 412. The opposite polarity of the DC power source 305 is electrically coupled to the conductive material 106. The DC power source 305 may generate a voltage of about 30-100 KVdc. The charged insulation material particles 412 migrate under the influence of the electric field generated by the DC power source 305 to the outside surface of the conductive material 106 to thereby cover the entire outside surface of the conductive material 106 with insulation material particles 412.

The insulation material particles 412 may correspond to any particles capable of carrying a charge. For example, the particles may correspond to various polymers, pigments, dies, and ceramics. Different materials with similar properties may be utilized.

The fourth exemplary embodiment is capable of producing an insulated busbar 120 having an insulation layer with a thickness of least between 20 μm and 125 μm, a leakage current of less than 10 mA, and an insulation resistance of at least 100 MΩ when measured with 500V DC applied across the insulated busbar 120 having.

In the third and fourth exemplary embodiments, a curing section 112, such as the curing section described above, may be provided to cure the insulated busbar 120 as it exits the deposition chamber (310, 410). In the third embodiment, the curing section 112 may apply heat to accelerate the removal of any solvents present in the colloidal insulation material particles 312. The heat may also cause the colloidal insulation material particles 312 to disperse evenly around the outside surface of the conductive material 106, to thereby form a lasting bond between the insulation material 108 and the conductive material 106.

Similarly, in the fourth embodiment, heat generated in the curing section 112 may be utilized to melt the insulation material particles 412 deposited on the outside surface of the conductive material 106 to thereby form a lasting bond between the insulation material 108 and the conductive material 106.

In both embodiments, a cutting station 115, such as the cutting station described above, may be provided to cut the busbar assembly 120 into arbitrary or fixed length insulated busbar sections. An etching station (not shown) may be provided to etch portions of the insulation material 108 from the insulated busbar 120 to expose the conductive material 106. Additionally, or alternatively, tape may be provided to certain areas of the conductive material 106 to prevent the particles 312, 412 from depositing on the taped areas of the conductive material 106 during the deposition phase. The particles 312, 412 may be removed prior to curing by vacuuming the particles 312, 412 off the conductive material 106 via one or more vacuum nozzles (not shown). Other processes may be utilized to prevent the particles from depositing on the conductive material 106, or to remove the particles 312, 412 from the conductive material 106 prior to curing.

In operation, the conductive material 106 may roll off the reel of conductive material 105 and into the deposition chamber (310, 410), where the colloidal insulation material particles 312/insulation material particles 412 migrate under the influence of the electric field generated by the DC power source 305 toward the conductive material 106. The feed rate at which the conductive material 106 moves through the deposition chamber (310, 410) may be about 2-5 feet per minute.

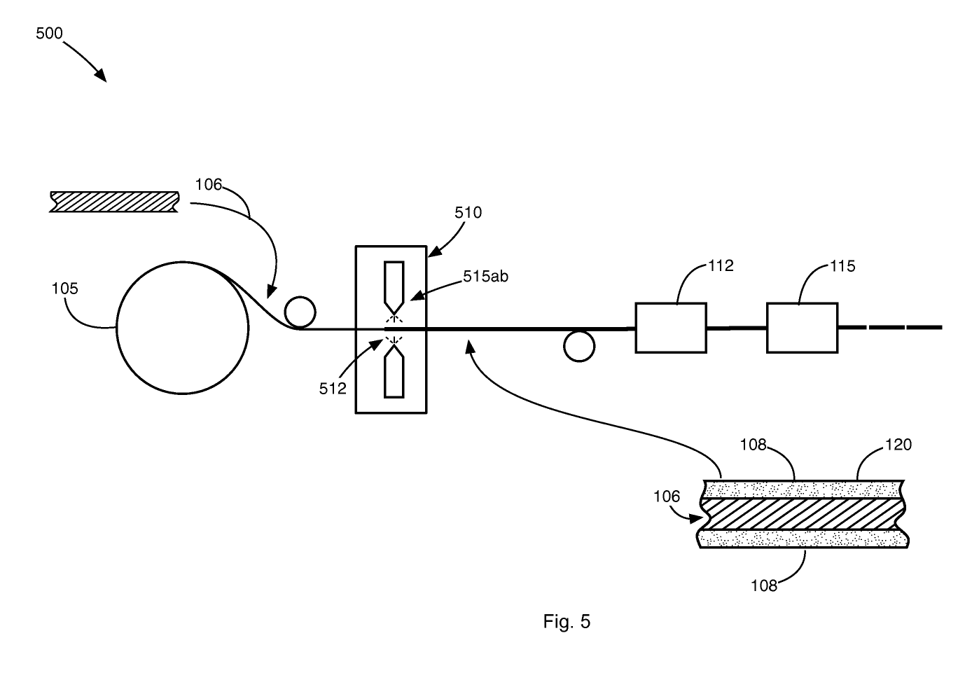

FIG. 5 illustrates a fifth exemplary embodiment 500 of a system for manufacturing an arbitrarily long insulated busbar. Shown is a reel of conductive material 105, a spray chamber 510, a curing station 112, and a cutting station 115.

The spray chamber 510 is configured to spray a mixture 512 of colloidal insulation material particles suspended in a solvent, such as xylene, onto the surface of the conductive material 106. A pair of nozzles 515ab in the spray chamber may be provided for spraying the mixture 512. The tips of the nozzles 515ab may be configured to control the amount of spray deposited on the conductive material 106 and the width of the spray pattern. In this way, the insulation material 108 may be deposited on specific regions of the conductive material 106 and the thickness of the insulation material 108 may be adjusted. This in turn may render subsequent etching processes unnecessary.

A curing section 112, such as the curing section described above, may be provided to cure the insulated busbar 120 as it exits the spray chamber 510. The curing section 112 may apply heat to accelerate the removal of any solvents present in the insulation material 108. The heat may also cause the insulation material 108 to disperse evenly around the outside surface of the conductive material 106, to thereby form a lasting bond between the insulation material 108 and the conductive material 106.

A cutting station 115, such as the cutting station described above, may be provided to cut the insulated busbar assembly 120 into arbitrary or fixed length insulated busbar sections. In some implementations, an etching station (not shown) may be provided to etch portions of the insulation material 108 from the insulated busbar assembly 120 to expose the conductive material 106, as described above. Additionally, or alternatively, tape may be provided to certain areas of the conductive material 106 to prevent the mixture 512 from depositing on the taped areas of the conductive material 106 during the deposition phase. Other processes may be utilized to prevent the mixture 512 from depositing on the conductive material 106 prior to curing.

The fifth exemplary embodiment is capable of producing an insulation layer with a thickness of between about 13 μm and 100 μm, having a leakage current of less than 10 mA and an insulation resistance of at least 100 MΩ measured when 500V DC is applied across the insulated busbar 120.

In operation, the conductive material 106 may roll off the reel of conductive material 105 and into the spray chamber 510, where the mixture 512 is sprayed over the surface of the conductive material 105. The feed rate at which the conductive material 106 moves through the spray chamber 510 may be about 5 feet per minute.

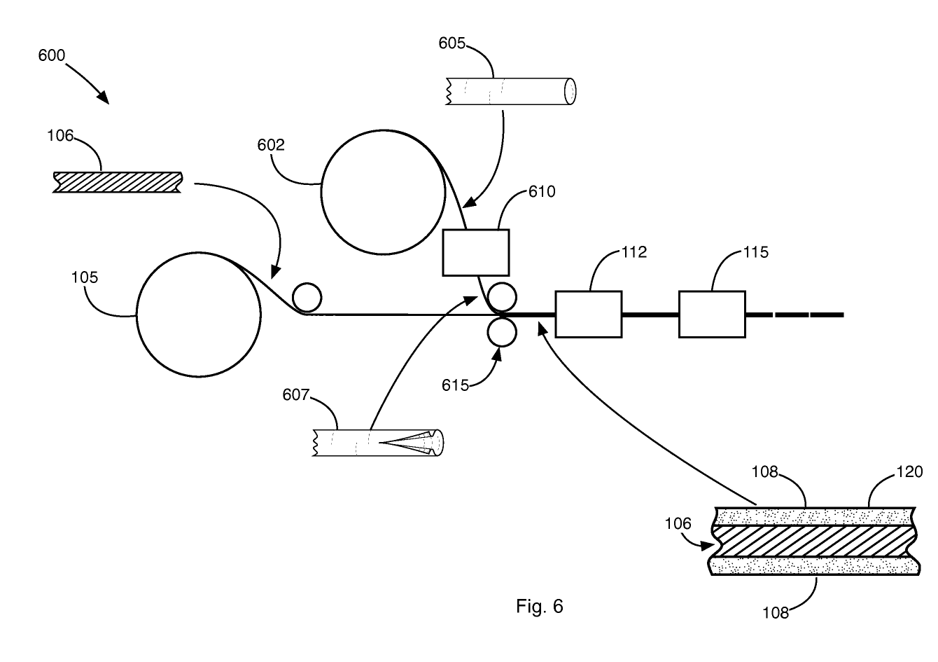

FIG. 6 illustrates a sixth exemplary embodiment 600 of a system for manufacturing an arbitrarily long insulated busbar. Shown is a reel of conductive material 105, a reel 602 of heat shrink tubing material 605, a slitting station 610, an insertion section 615, a curing station 112, and a cutting station 115.

The heat shrink tubing material 605 may be formed from a material such as polyolefin, polyvinyl chloride, nylon, polyester, fluoride polymer, or a different material configured to shrink when heated.

The slitting station 610 is configured to cut a slit in the heat shrink tubing material 605 to provide a continuous feed of slit heat shrink tubing material 607. For example, the slitting station 610 may include a blade that runs along the heat shrink tubing material 605 to cut the slit.

The insertion section 610 is configured to insert the conductive material 105 into the slit of the slit heat shrink tubing material 607. For example, the insertion section 610 may include one or more rollers that press the conductive material 106 into the slit of the slit heat shrink tubing material 607.

A curing/shrinking section 112, such as the curing section described above, may be provided to heat the slit heat shrink tubing material 107 as it exits the insertion section 615. The curing section 112 may apply a temperature of about 70-250 C to cause the heat shrink tubing to shrink around the conductive material 106.

A cutting station 115, such as the cutting station described above, may be provided to cut the insulated busbar assembly 120 into arbitrary or fixed length insulated busbar sections. In some implementations, an etching station (not shown) may be provided to etch portions of the insulation material 108 from the insulated busbar assembly 120 to expose the conductive material 106, as described above.

The sixth exemplary embodiment is capable of producing an insulation layer with a thickness of between about 13 μm and 100 μm, having a leakage current of less than 10 mA and an insulation resistance of at least 100 MΩ measured when 500V DC is applied across the insulated busbar 120.

In operation, the conductive material 106 may roll off the reel of conductive material 105, and the heat shrink tubing material 605 may roll off the reel of heat shrink tubing material 602. The heat shrink tubing material 605 may be cut via the slitting station 610 to provide a continuous feed of slit heat shrink tubing material 607. The conductive material 105 and the slit heat shrink tubing material 607 enter the insertion section 615, which continuously presses the conductive material 106 into the slit of the slit heat shrink tubing material 607. The feed rate at which the conductive material 106 and the slit heat shrink tubing material 607 move through the insertion section 610 may be about 5 feet per minute. The assembly is cured in the curing station 112 to provide a continuous feed of insulated busbar, which may then be cut at the cutting station 115 into discrete sections of insulated busbar.

While the method for manufacturing the insulated busbar has been described with reference to certain embodiments, it will be understood by those skilled in the art that various changes may be made and equivalents may be substituted without departing from the spirit and scope of the claims of the application. Other modifications may be made to adapt a particular situation or material to the teachings disclosed above without departing from the scope of the claims. For example, the operations described above may be applied equally well to pre-cut conductive material sections and/or assemblies of pre-cut conductive material sections, which may be welded together to provide an assembly of conductive sections, prior to forming an insulating later over the conductive material. Therefore, the claims should not be construed as being limited to any one of the particular embodiments disclosed, but to any embodiments that fall within the scope of the claims.

What is claimed is:

1. A method for manufacturing an insulated conductive material, the method comprising:
providing a continuous feed of a conductive material;
providing a first continuous feed of insulating material above a top surface of the conductive strip;
providing a second continuous feed of insulating material below a bottom surface of the conductive strip;
compressing portions of the first and second continuous feeds of insulating material against a portion of the conductive material; and
curing the portions of the first and second insulating material to thereby provide a continuous feed of insulated conductive material.

2. The method according to claim 1, further comprising cutting the continuous feed of insulated conductive material to provide a discrete length of the insulated conductive material.

3. The method according to claim 1, further comprising removing portions of the insulating material from the insulated conductive material to expose the conductive material.

4. The method according to claim 1, wherein the insulating material corresponds to one of:
polyolefin, polyvinyl chloride, nylon, polyester, fluoride polymer, and PEI.

5. The method according to claim 1, wherein the insulating material corresponds to an adhesive layer.

6. The method according to clam 1, further comprising heating the first and second continuous feeds of insulating material to a temperature of at least 60 C prior being compressing portions of the first and second continuous feeds of insulating material against a portion of the conductive material.

7. A method for manufacturing an insulated conductive material, the method comprising:
providing a continuous feed of a conductive material;
providing an extrusion mold that defines an extrusion opening sized larger than a cross-section of the conductive material;
inserting an insulating material into the extrusion mold;
running the continuous feed of a conductive material through the extrusion mold and out the extrusion opening, wherein the extrusion mold is configured such that an entire outside surface of the conductive material is covered with the insulating material when the conductive material exits the extrusion mold; and
curing the insulated conductive material as it exits the extrusion mold to thereby provide a continuous feed of insulated conductive material.

8. The method according to claim 7, further comprising cutting the feed of insulated conductive material to provide a discrete length of the insulated conductive material.

9. The method according to claim 7, further comprising removing portions of the insulating material from the insulated conductive material to expose the conductive material.

10. The method according to claim 7, wherein the insulating material corresponds to one of:
polyolefin, polyvinyl chloride, nylon, polyester, and fluoride polymer.

11. A method for manufacturing an insulated conductive material, the method comprising:
providing a continuous feed of a conductive material;
electrically charging the conductive material with a first charge polarity;
providing a medium of electrically charged insulating material particles that are charged with an opposite polarity;
passing the charged conductive material through the medium, whereby the insulating material particles bind to the conductive material and cover an entire outside surface of the conductive material; and
curing the insulating material particles to thereby provide a continuous feed of insulated conductive material.

12. The method according to claim 11, wherein the medium of electrically charged insulating material corresponds to insulating colloidal particles suspended in a liquid medium.

13. The method according to claim 12, wherein the insulating material corresponds to one of: acrylate, epoxy, and polyurethane base resins.

14. The method according to claim 11, wherein the medium of electrically charged insulating material corresponds to an insulating provided in a powder form.

15. The method according to claim 14, wherein the insulating material corresponds to one of: epoxy, epoxy/polyester hybrid, polyester, and acrylic resin.

16. The method according to claim 11, further comprising cutting the feed of insulated conductive material to provide a discrete length of the insulated conductive material.

17. The method according to claim 11, further comprising removing portions of the insulating material from the insulated conductive material to expose the conductive material.

18. A method for manufacturing an insulated conductive material, the method comprising:
providing a continuous feed of a conductive material;
spraying an insulating material over the exterior surface of the conductive material; and
curing the insulating material particles to thereby provide a continuous feed of insulated conductive material.

19. The method according to claim 18, wherein the insulating material corresponds to particles of an insulating material diluted in a solvent.

20. The method according to claim 19, wherein the insulating material corresponds to one of:
acrylic, epoxy, and polyurethane resins.

21. The method according to claim 18, further comprising cutting the feed of insulated conductive material to provide a discrete length of the insulated conductive material.
